(19) United States
(12) Patent Application Publication
(10) Pub. No.: US 2002/0193142 A1
(43) Pub. Date: Dec. 19, 2002

(54) System and method for controlling access to personal information

(76) Inventors: Bengt Stavenow, Lund (SE); Stefan Andersson, Klagerup (SE)

Correspondence Address: JENKENS & GILCHRIST, P.C., Suite 3200, 1445 Ross Avenue, Dallas, TX, 75202-2799, US

(21) Appl. No.: 10/123,506

(22) Filed: Apr. 15, 2002

Related U.S. Application Data
(60) Provisional application No. 60/291,052, filed on May 14, 2001.

(51) Int. Cl. H04M 1/00

(52) U.S. Cl. 455/556; 455/557; 455/411

(57) ABSTRACT

A mobile communications device includes a fingerprint scanner for generating a scanned fingerprint output data responsive to a scanned fingerprint. The scanned fingerprint output is compared to a reference fingerprint pattern such that a code memo application containing a plurality of data entries each having an associated identifier may be temporarily accessed during a selected period of time if the scanned fingerprint output data matches the reference fingerprint pattern. During the selected period, one of the plurality of data entries may be selected and inserted into a dialog.

### RELATED APPLICATION(S)

This application claims priority from and incorporates herein by reference the entire disclosure of U.S. Provisional Application Serial No. 60/291,052 filed May 14, 2001.

### TECHNICAL FIELD

The present invention relates to the use of personal information such as PIN codes, and more particularly, to a system and method for controlling access to PIN codes using fingerprint scanner technology.

### BACKGROUND OF THE INVENTION

An increasing problem for users of services provided via the Internet is the large amount of personal information required to access particular websites or information. Personal information such as a user name, addresses or user IDs are rather long alphanumeric strings that are cumbersome to enter by means of a mobile telephone or other computing device. The increasing number of personal information enabled accesses to data requires a user to remember many PIN numbers, passwords or user names in order to access a particular website or particular type of information.

A PIN may be used to open up files within a memory area on a secure token such as a SIM, WIM, or smart card. Additionally, a PIN may provide access to services within a network. In the case of utilizing a PIN to open a file within a memory area on a secure token, the secure token typically stores a private key to be used in a digital signature operation or with other types of data requiring a high degree of protection. For each type of secure token, an associated security policy states the rules for providing access to individual files within memory on the secure token. The security policy may impose rules requiring entry of a PIN each time the information is accessed. Another rule may require the PIN for the private key used for a digital signature to be different from the PIN used for other operations such as client authorization. Thus, the effect of the security policy may require the end user to remember a set of different PINs required to be entered on a rather frequent basis. With the introduction of WAP, Internet technologies and open execution environments within the MExE framework, there has become an increased demand for user friendly management of numerous PINs within a mobile station or other computing device. A user friendly and secure feature for automatically form filling personal information would assist with entry of this information. There is a need for secure and user friendly manner of managing and making use of a large number of PINS within the mobile station or other computing device.

### SUMMARY OF THE INVENTION

The present invention overcomes the foregoing and other problems with a system for controlling access to personal information. A device includes a fingerprint scanner for scanning the fingerprint of a user and generating scanned fingerprint output data. This scanned fingerprint output data is compared to a reference fingerprint pattern to determine whether or not they match. If the scanned fingerprint output data and the reference fingerprint pattern match, access is provided for a selected period of time to a listing of data entries each having associated text identifiers. During the selected time period, one of the data entries may be selected. The selected data entry is inserted into a dialog which has been generated in response to a request for the data entry from an application or outside device.

The selection may occur by display of the text identifiers on a user interface of the mobile communication device and selection of one of the text identifiers by the user of the mobile communication device. Alternatively, the selection of the data entry may be made by identifying a tag within the request for the data entry and automatically selecting a data entry associated with that tag. Furthermore, in addition to the text labels, the data entries may have associated therewith specific applications with which the data entry is associated. The application making a request for a data entry is determined, and the data entry associated with the identified application selected and inserted within the dialog.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a block diagram of the system of the present invention;

FIG. 2 is an illustration of a memory storing PIN numbers having associated text labels;

FIG. 3 illustrates a memory with PIN numbers having associated text labels and applications;

FIG. 4 illustrates interaction between a mobile station implementing the system of the present invention and an application located in the mobile station;

FIG. 5 illustrates a mobile station implementing the system of the present invention interacting with a PC;

FIG. 6 illustrates a request including a tag for accessing a particular PIN number, and

FIG. 7 is a flow diagram illustrating the operation of a system of the present invention.

### DETAILED DESCRIPTION

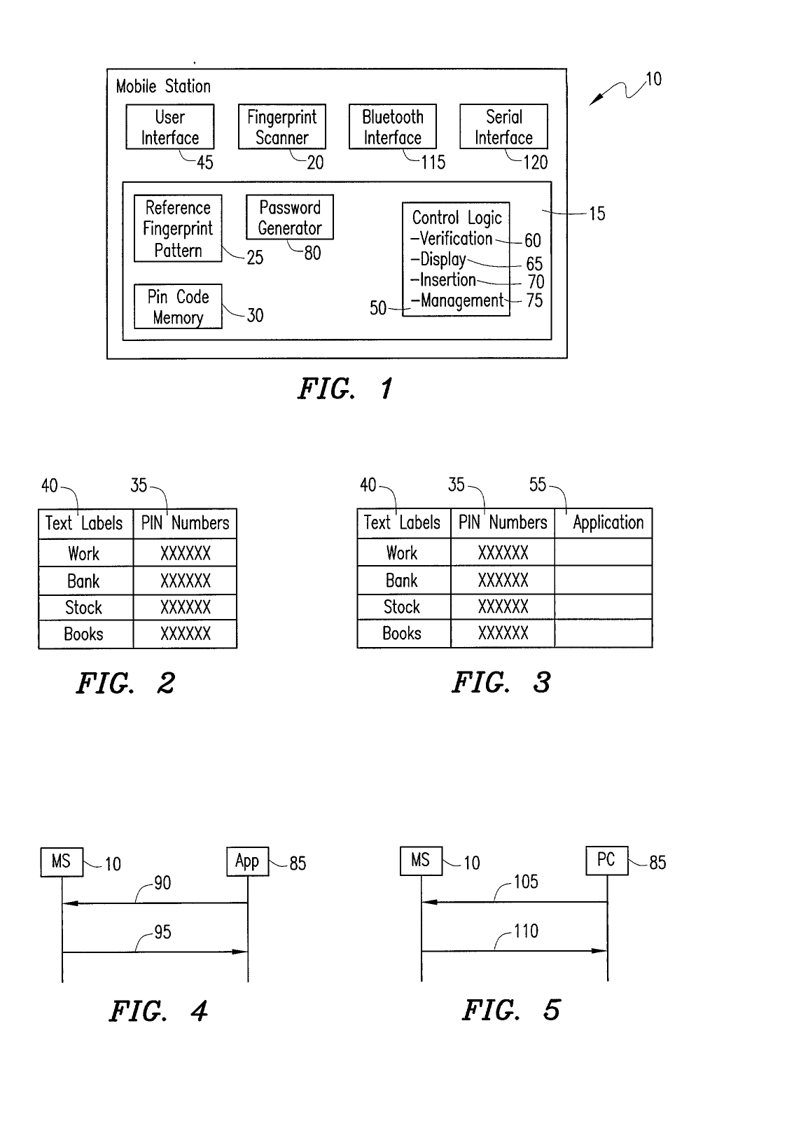

Referring now to the drawings, and more particularly to FIG. 1, there is illustrated a mobile station 10 including a code memo application 15 accessed via a fingerprint scanner 20. While the present discussion describes a system implemented within a mobile station 10 of a wireless communications network, it should be realized that the system and method of the present invention may be implemented within any computing device requiring the entry of personal information such as PIN codes, user IDs, passwords or other types of similar information. The code memo application 15 may be implemented within hardware and software of the mobile station 10 and form an integral portion of the mobile station 10 itself Alternatively, the code memo application 15 may be implemented on a secure token such as a SIM or WIM on a removable card or a smart card. The term “secure token” is used as a generic term for any type of security element that is used in relation to the mobile station 10 and where the implementation of the element is based on smart card technology. Examples of such security elements are a SIM, a WIM, or any other type of chip card

The code memo application 15 includes a reference fingerprint pattern 25 of a user consisting of data from a fingerprint scan and may comprise a scan of an entire fingerprint, selected reference points from the fingerprint, etc. The reference fingerprint pattern 25 is used for accessing a PIN code memory 30, or other user related data such as user IDs, passwords, etc. stored the code memo application 15. The PIN code memory 30 which is more fully illustrated in both FIGS. 2 and 3 may be configured in a number of fashions In the embodiment illustrated in FIG. 2, a plurality of PIN numbers 35 associated with a particular user are stored in a first memory location. Associated with each of the PIN 35 in a second memory location are user designated text labels 40. When a user is selecting a particular PIN number as will be more fully described in a moment, the user designated text labels 40 are displayed to and selected by the user through a user interface 45. Multiple PIN numbers 35 may be stored in either an encoded format or in a protected file on a secure token. Control/opening of the PIN code memory 30 is accomplished using the fingerprint scanner 20 and control logic 50 within the code memo application 15 Alternatively, as shown in FIG. 3, the PIN codes 35, in addition to being associated with a particular text label 40, may also have association therewith a particular application 55 or a specific PIN input dialog within the application. In this case, access of the code memo application 15 by a particular application triggers automatic provision of a PIN number 35 associated with the application after accessing of the PIN code memory 30 by verification of a scanned fingerprint input. Thus, the user does not have to scroll through and select a particular PIN.

The control logic 50 controls the procedure by which access is provided to information stored within the PIN code memory 30. The control logic 50 consists of a verification function 60, display function 65, insertion function 70 and management function 75. These functions are implemented in hardware, software, or firmware or a combination thereof The verification function 60 controls comparison of the reference fingerprint pattern 25 to a scanned fingerprint output received from the fingerprint scanner 20. If the scanned fingerprint output data, which may comprise an entire fingerprint scan, selected reference points or any other technique known for representing scanned fingerprint data, received from the fingerprint scanner 20 matches the reference fingerprint pattern 25, the PIN code memory 30 is accessible for a selected period of time, and the display function 65 utilizes the user interface 45 to display a list of text labels that are associated with PIN numbers of a user. A user, utilizing the user interface 45, selects a particular text label 40 associated with one of the PIN numbers 35. The display function 65 and verification function 60 only keeps the PIN codes open to be accessed by the user for a selected period of time. If a user does not select a particular text label 40 within the selected period of time, access to the PIN code memory 30 is ended and the user must reaccess the PIN codes by again having their fingers scanned by the fingerprint scanner 20. The insertion function 70 inserts the selected PIN number 35 within the PIN dialog associated with information a user is attempting to access.

The management function 75 enables the user to alter information stored within the PIN code memory 30 and the reference fingerprint pattern 25. The management 75 function which is also accessible using the fingerprint scanner 20 enables PIN numbers 35 in the PIN code memory 30 to be specified, deleted or changed. Additionally, text labels 40 may be added or changed, and a length of a time before which access to the PIN memory code 30 is discontinued after a successful opening may also be controlled. The reference fingerprint pattern also may be changed to accommodate different users.

One time password generator 80 may be related to a particular PIN name 35/text label 40. When a text label 40 is selected, a one time password is automatically generated and inserted into the PIN dialog by the insertion logic 70. The one time password generator 80 is useful if the PIN code/password should be sent to a server/receiver other than the mobile station 10. The one time password generator 80 implies an encryption of the password over the communication channel may not be required The password generator provides additional security for transmitted passwords by using a password only a single time.

Referring now to FIGS. 4 and 5, there are illustrated manners in which the control logic 50 would be initiated to display the text labels 40 for various PIN numbers 35 to a user via a user interface 45. In a first embodiment, an application 85 requests at 90 a PIN number from the mobile station 10. The application 85 resides internally of the mobile station 10. In response to the request, a dialog screen requests input of certain user information, and the user provides a fingerprint scan of their fingerprint to the fingerprint scanner 20 in an attempt to access the PIN memory code 30 to provide this information. If successful PIN code memory access is achieved, a response 35 including the required PIN code information is transmitted back to the application 85.

In another embodiment of the invention, the PIN dialog provided to the user may be invoked not by an application 85 associated with the mobile station but by a signal received externally from another device as an AT command received through a Bluetooth interface 115 or serial interface 120 (FIG. 1). An example of one configuration is illustrated in FIG. 5 wherein a PC 100 may be running, for example, an E-commerce application. When an application on the PC 100 requests a PIN code via a dialog, the PC application transmits an AT command 105 to the mobile station 10 over a Bluetooth or serial connection. The PIN input dialog appears on the mobile station user interface 45, and a response 110 including a PIN 35 is transmitted over an external interface as an AT command back to the PC 100 after a text label is selected by a user. Since the PIN is transmitted over an external interface, the PIN is preferably related to a one time password generated by the password generator 80.

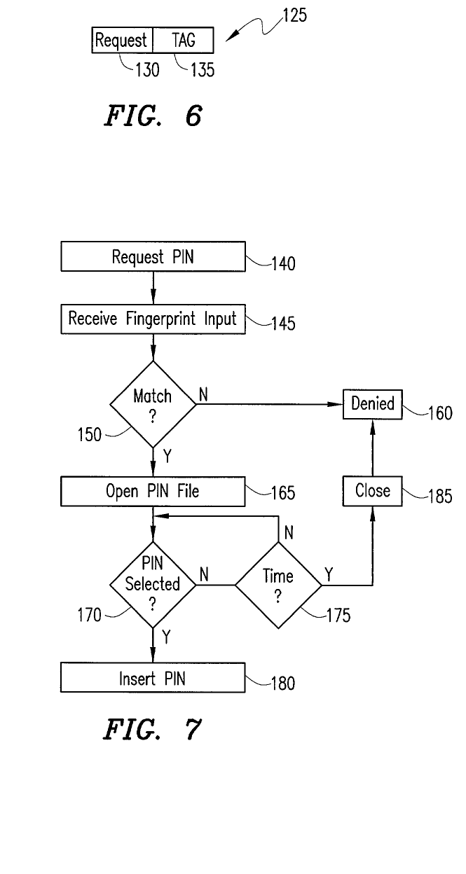

In a further embodiment of the invention, the PIN information requested by an application may be related to a specific tag included in an application protocol. As illustrated in FIG. 6, the request transmitted for information in a PIN dialog would include the request 130 and the associated tag 135. The tag 135 is generic such that the code memo application 15 may relate the specific tag to information saved within the PIN code memory 30 and enable it to be generated automatically. An example of such technology is the IETF (Internet Engineering Task Force) standard referred to as ECML (E-commerce Markup Language). The ECML standard specified main fields for markup language, such as WMT (Wireless Markup Language) and XHTML (Extended Hypertext Markup Language), such that markup language forms could be automatically filled in.

Referring now to FIG. 7, there is illustrated a flow diagram describing the operation of the system illustrated in FIG. 1 and discussed above. An application requiring a particular PIN number for a PIN dialog requests at step 140 a PIN input. In response to the PIN request, a further input must be received at step 145 from a user consisting of a fingerprint scan from the fingerprint scanner 20. This is accomplished by a user placing the appropriate finger over the fingerprint scanner 20 associated with the mobile station 10 and having a scan made of the fingerprint. Inquiry step 150 determines if the proper fingerprint scan has been received by comparing it with the reference fingerprint pattern 25. If the incorrect fingerprint scan is received, the procedure ends at step 160. Otherwise, the PIN code memory 30 is open to access at step 165 for a selected period of time. After the PIN code memory 30 is opened, inquiry step 170 determines if a text label associated with a particular PIN number has been input. If not, inquiry step 175 determines if the time period for maintaining open access to the PIN code memory 30 has expired. If not, control passes back to step 170 to continue monitoring for input of a selected text label Upon expiration of the timer, inquiry step 125 closes the PIN code memory 30 at step 155 and ends the process at step 160. If a selected text label is received at step 170, the PIN number associated with the selected text label is inserted into the appropriate PIN dialog at step 180.

While the foregoing discussion has specifically been described with respect to a system requiring a PIN input to a PIN dialog, it should be realized that the system is equally applicable to any system requiring the input of particular user information such as name, user ID, password, address, etc. that the user may wish to protect but may be periodically required to be entered by the user in response to a particular dialog input request from various applications.

The previous description is of a preferred embodiment for implementing the invention, and the scope of the invention should not necessarily be limited by this description. The scope of the present invention is instead defined by the following claims.

What is claimed is:

1. A computing device, comprising:
a fingerprint scanner for generating a scanned fingerprint output data responsive to a scanned fingerprint;
a reference fingerprint pattern; and
a code memo application containing at least one piece of data having an identifier associated therewith, wherein said code memo application is accessible for only a selected period of time if the scanned fingerprint output data matches the reference fingerprint pattern.

2. The computing device of claim 1, wherein the code memo application inserts a selected piece of data into a dialog.

3. The computing device of claim 1, wherein the code memo application selects and inserts at least one piece of data into a dialog responsive to a tag within a received request.

4. The computing device of claim 1, wherein the code memo application selects and inserts the at least one piece of data into a dialog responsive to determination of an application providing a request.

5. The computing device of claim 1, wherein the computing device comprises a mobile communication device.

6. The computing device of claim 1, wherein the code memo application further displays the identifier associated with the at least one piece of data for selection by a user during the selected period of time.

7. The computing device of claim 1, wherein the code memo application further comprises:
a memory for storing the at least one piece of data and the associated identifier, said memory accessible only during the selected period of time.

8. The computing device of claim 7, wherein the memory further stores an application associated with the at least one piece of data.

9. The computing device of claim 1, wherein the at least one piece of data comprises at least one PIN number.

10. The computing device of claim 1, further including a password generator for generating a password for combination with the at least one piece of data.

11. A mobile communications device, comprising:
a fingerprint scanner for generating a scanned fingerprint output data responsive to a scanned fingerprint,
a reference fingerprint pattern for comparison to the scanned fingerprint output data; and
a code memo application containing a plurality of data entries, each of said plurality of data entries have a text label associated therewith, wherein said code memo application is configured to display text labels associated with the plurality of data entries and provide access to the plurality of data entries for a selected period of time if the scanned fingerprint output data matches the reference fingerprint pattern, said code memo application further configured to insert a selected data entry into a dialog responsive to selection of a text label associated with the selected data entry.

12. The mobile communication device of claim 11, wherein the code memo application selects and inserts the selected data entry into a dialog responsive to a tag within a received request.

13. The mobile communication device of claim 11, wherein the code memo application selects and inserts the selected data entry into a dialog responsive to determination of an application providing a request

14. The mobile communication device of claim 11, wherein the code memo application further comprises:
a memory for storing the plurality of data entries and the associated text labels, said memory accessible only during the selected period of time.

15. The mobile communication device of claim 14, wherein the memory further stores an application associated with each of the plurality of data entries.

16. The mobile communication device of claim 11, wherein the plurality of data entries comprises a plurality of PIN numbers.

17. The mobile communication device of claim 11, further including a password generator for generating a password for combination with the at least one piece of data.

18. A mobile communication device, comprising:
a fingerprint scanner for generating a scanned fingerprint output data responsive to a scanned fingerprint;
a reference fingerprint pattern;
a memory for storing a plurality of PIN numbers each of said PIN numbers having a text label associated therewith, said memory accessible for only a selected period of time;
a user interface;
control logic for comparing the scanned fingerprint output data to the reference fingerprint pattern and providing access to the memory for the selected period of time if the scanned fingerprint output data and the reference fingerprint pattern match, for displaying the text labels associated with each of the plurality of PIN numbers on the user interface, and for inserting a selected PIN number into a dialog responsive to selection of a text label associated with the selected PIN number.

19. The mobile communications device of claim 18, wherein the control logic selects and inserts the selected PIN number into the dialog responsive to a tag within a received request.

20. The mobile communications device of claim 18, wherein the control logic selects and inserts the selected PIN number into the dialog response to determination of an application providing a request.

21. The mobile communications device of claim 18, wherein the memory further stores an application associated with each of the plurality of PIN numbers.

22. The mobile communication devices of claim 18, further including a password generator for generating a password for combination with a PIN number.

23. A method for controlling access to user data, comprising the steps of:
receiving a scanned fingerprint output from a fingerprint scanner;
comparing the scanned fingerprint output to a reference fingerprint pattern;
providing access to a plurality of data entries having associated identifiers for a selected period of time if the scanned fingerprint output matches the reference fingerprint pattern;
selecting one of the plurality of data entries during the selected period of time; and
inserting a selected data entry into a dialog.

24. The method of claim 23, wherein the step of selecting further comprises the steps of:
displaying the associated identifiers for each of the plurality of data entries during the selected time period; and
receiving a selection input of one of the associated identifiers corresponding to the selected data entry.

25. The method of claim 23, wherein the step of selecting further comprises the steps of.
identifying a tag associated with a request for one of the plurality of data entries;
determining a data entry of the plurality of data entries associated with the tag; and
selecting the data entry associated with the tag as the selected data entry.

26. The method of claim 23, wherein the step of selecting further comprises the steps of:
determining an application making a request for one of the plurality of data entries;
accessing the plurality of data entries having associated identifiers, each of the plurality of data entries further having an application indicator associated therewith to determine a data entry associated with the application; and
selecting the data entry associated with the identified application.
